(19) United States
(12) Patent Application Publication
(10) Pub. No.: US 2009/0201816 A1
(43) Pub. Date: Aug. 13, 2009

(54) COMMUNICATION DEVICE, AND FLOW CONTROL METHOD AND PROGRAM PRODUCT FOR USE IN THE SAME

(76) Inventor: Taishi TAKAHASHI, Tokyo (JP)

Correspondence Address: NEC CORPORATION OF AMERICA, 6535 N. STATE HWY 161, IRVING, TX, 75039, US

(21) Appl. No.: 12/362,355

(22) Filed: Jan. 29, 2009

(30) Foreign Application Priority Data
Feb. 13, 2008 (JP) 2008-031190

(51) Int. Cl. H04L 12/26; H04L 5/14

(52) U.S. Cl. 370/235; 370/276

(57) ABSTRACT

A communication device includes a full-duplex communication portion that communicates bidirectionally with an opposing device, a receive buffer that retains data received from the opposing device at the full-duplex communication portion, and a pause portion that carries out flow control in full-duplex communication. The pause portion carries out the flow control according to a pause level determined based on the degree of accumulation at the receive buffer and a processing load at the communication device itself.

### INCORPORATION BY REFERENCE

This application is based upon and claims the benefit of priority from Japanese patent application No. 2008-031190, filed on Feb. 13, 2008, the disclosure of which is incorporated herein in its entirety by reference.

### BACKGROUND OF THE INVENTION

1. Technical Field

The present invention relates to a communication device, and a flow control method and program product for use in the same, and in particular to a flow control technique in full-duplex communication.

2. Background Art

Examples of the flow control techniques related to the present invention include the PAUSE function specified in IEEE (Institute of Electrical and Electronic Engineers) 802.3. This Pause function enables flow control to be carried out in a Full-Duplex Ethernet (registered trademark) link.

Therefore, in a device designed to cope with a load that would occurs when the network traffic and its load in the expected stabled state are temporarily increased to a certain extent, when a load larger than the expected level is temporarily imposed, a pause frame is transmitted to a device at the other end in the full-duplex link so that the device at the other end that received the pause frame stops the transmission of data frames.

Consequently, this flow control technique can prevent switches or terminals from unnecessarily discarding frames due to the input buffer overflow caused by a temporary overload state.

Such a flow control technique enables the construction of a system capable of avoiding the buffer overflow with simple mechanism such as stop (including information about stop time)/restart. Furthermore, although the pause frame suppresses the transmission of data frames, it does not have any effect on the transmission of a MAC (Media Access Control) frame (e.g., a pause frame in the opposite direction).

This kind of flow control technique includes a technique in which frames that are received from a device connected to a communication port and have priority assigned thereon are accumulated in a queue depending on the priority or priority group, and then when a frame amount accumulated in each queue exceeds its corresponding threshold, a transmission stop instruction frame that instructs the stop of the transmission for that priority or priority group is transmitted to the device connected to the communication port, and when the frame amount does not exceeds the threshold, a transmission restart instruction frame that instructs the restart of the transmission for that priority or priority group is transmitted to the device connected to the communication port (For example, see Japanese Unexamined Patent Application Publication No. 2006-020027 (Katayama et al.)).

In such a case, when the device connected to the communication port receives the transmission stop instruction frame for any of the priorities or priority groups, it stops the transmission of frames corresponding to that priority or priority group, and when it receives the transmission restart instruction frame for any of the priorities or priority groups, it restarts the transmission of frames corresponding to that priority or priority group. By doing so, this flow control technique enables satisfactory flow control.

In flow control by the above-mentioned pause function related to the present invention, when the node on the receiving side is too busy with current processing to process received frames or when the buffer on the receiving side is full at to the point of overflowing so that frames cannot be received, all frames are temporarily stopped regardless of the priority thereof in order to prevent frames from being discarded.

Therefore, there is a possibility in the above-mentioned flow control that the transmission of data that is sensitive to time, such as audio data and video data is suspended for a long time, and thus a possibility that it gives an adverse effect to users such as interruptions in sound and disruptions in video image.

That is, in the flow control related to the present invention, when the processing at the receiving node or the load at the receiving buffer is increased to such a level that it cannot receive a frame and a frame could be discarded, all frames are temporarily stopped regardless of the priority thereof in order to prevent frames from being discarded. Therefore, in this flow control, there is a possibility that the transmission is stopped even for data having a high priority so that a delay occurs in the transmission of important data.

In the flow control described in the above-mentioned Katayama et al., when the frame amount of any of queues that are prepared according to priority exceeds its corresponding threshold, it instructs to stop the transmission individually from the queue for which the frame amount exceeds the threshold. Therefore, it cannot solve the above-mentioned problem that occurs in the case where all frames are temporarily stopped regardless of the priority of the frames.

### SUMMARY

Accordingly, an exemplary object of the present invention is to provide a communication device capable of solving the above-mentioned problems and minimizing the effect of the frame discarding due to increase in the load at the node for frames having a high priority, and a flow control method for use in the communication device.

In accordance with an exemplary aspect of the invention, a communication device includes: a full-duplex communication portion that communicates bidirectionally with an opposing device; a receive buffer that retains data received from the opposing device at the full-duplex communication portion; and a pause portion that carries out flow control in full-duplex communication according to a pause level determined based on the degree of accumulation at the receive buffer and a processing load at the communication device itself.

A flow control method in accordance with an exemplary aspect of the present invention provides a flow control method for use in a communication device. This flow control method communicates bidirectionally with an opposing device, retains data received from the opposing device at a receive buffer, and carries out flow control in full-duplex communication according to a pause level determined based on the degree of accumulation at the receive buffer and a processing load at the communication device itself.

A program product in accordance with an exemplary aspect of the present invention causes a communication device to execute a process to communicate bidirectionally with an opposing device, a process to retain data received from the opposing device at a receive buffer, and a process to carry out flow control in full-duplex communication according to a pause level determined based on the degree of accumulation at the receive buffer and a processing load at the communication device itself.

The above and other objects, features and advantages of the present invention will become more fully understood from the detailed description given hereinbelow and the accompanying drawings which are given by way of illustration only, and thus are not to be considered as limiting the present invention.

### BRIEF DESCRIPTION OF THE DRAWINGS

FIG. 1 is a block diagram illustrating a configuration example of a communication device in accordance with an exemplary embodiment of the present invention;

FIG. 2 is a block diagram illustrating a configuration example of a communication system in accordance with an exemplary embodiment of the present invention;

FIG. 3A shows thresholds for detecting increase in degree of accumulation at a receive buffer for use in an exemplary embodiment of the present invention:

FIG. 3B shows thresholds for detecting increase in a processing load for use in an exemplary embodiment of the present invention:

FIG. 4 shows a configuration of a pause level table retained in a memory shown in FIG. 2;

FIG. 5 shows a frame format of a control frame for use in a pause function portion shown in FIG. 2;

FIG. 6 is a flowchart illustrating flow control operation with priority taken into account in accordance with an exemplary embodiment of the present invention;

FIG. 7 is a flowchart illustrating flow control operation with priority taken into account in accordance with an exemplary embodiment of the present invention;

FIG. 8 is a flowchart illustrating flow control operation with priority taken into account in accordance with an exemplary embodiment of the present invention;

FIG. 9 is a flowchart illustrating flow control operation with priority taken into account in accordance with an exemplary embodiment of the present invention;

FIG. 10 is a flowchart illustrating flow control operation with priority taken into account in accordance with an exemplary embodiment of the present invention; and

FIG. 11 is a flowchart illustrating flow control operation with priority taken into account in accordance with an exemplary embodiment of the present invention.

### EXEMPLARY EMBODIMENT

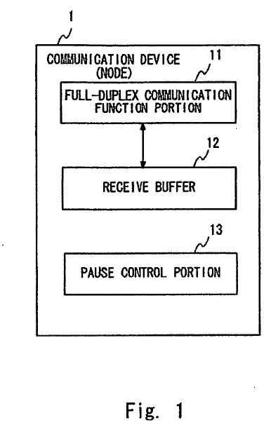

Next, exemplary embodiments of the present invention are explained hereinafter with reference to the drawings. Firstly, a concept of the present invention is explained. FIG. 1 is a block diagram illustrating a configuration example of a communication device in accordance with an exemplary embodiment of the present invention. In FIG. 1, a communication device (a network device, a terminal, or the like (hereinafter called “node”)) 1 in accordance with an exemplary embodiment of the present invention includes a full-duplex communication function portion 11 to communicate bidirectionally with an opposing device, a receive buffer 12, and a pause control portion 13 to control a pause (PAUSE) function with priority taken into account.

In one aspect, the present invention is to minimize the effect of the frame discarding due to increase in the load at the node 1 for frames having a high priority by taking the priority into account in full-duplex communication flow control by the pause control portion 13 (a function specified in IEEE 802.3: a function to carry out flow control in full-duplex communication) of the node 1 having the above-mentioned full-duplex communication function portion 11.

In one aspect, the present invention temporarily stops the transmission of frames from frames having lower priority when processing load at the node on the receiving side or the degree of accumulation at the receive buffer increases and thereby the possibility of the frame discarding becomes higher. Then, in the present invention, the transmission of all frames is temporarily stopped when the margin is lost with further increase in the processing load of the node or the degree of accumulation at the receive buffer.

In this way, since only the frames having a higher priority are transmitted even when the load at the node is increased in the present invention, it can delay the temporary stop of the transmission of frames having a higher priority. Furthermore, since the transmission of frames having a lower priority is temporarily stopped in the present invention, it is possible to alleviate the increase rate of the load at the node. Therefore, an overload state at the node could be dissolved before it reaches the limit. As a result, the possibility that the temporary stop of the transmission of frames having a higher priority will be avoided becomes higher.

Furthermore, in the present invention, the frame transmission is restarted from frames having a higher priority as the margin is restored with decrease in the processing load at the receiving node or the degree of accumulation at the receive buffer during the temporal stop of the frame transmission. Then, in the present invention, all frame transmission is restarted when the processing load and the degree of accumulation at the receive buffer are sufficiently decreased.

Therefore, in the present invention, when the load state at the receiving node is on the decrease, the transmission can be restarted preferentially for frames having a higher priority, so that it is possible to minimize the temporary transmission stop time for frames having a higher priority.

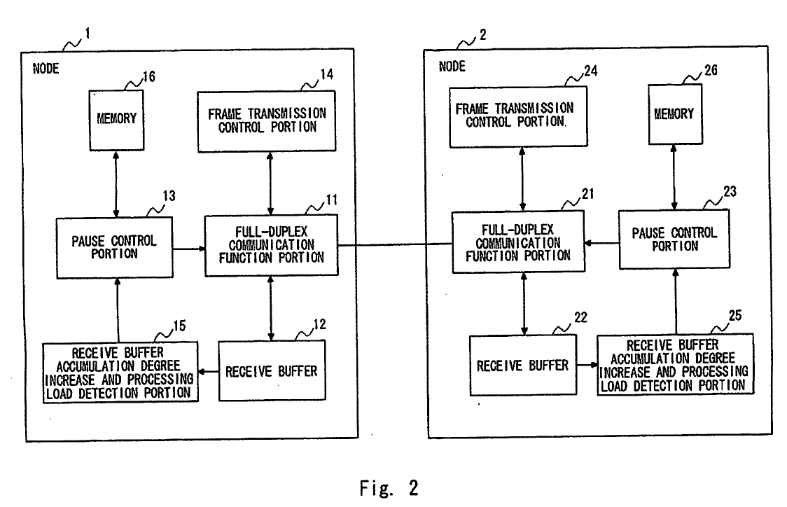

FIG. 2 is a block diagram illustrating a configuration example of a communication system in accordance with an exemplary embodiment of the present invention. In FIG. 2, a communication system in accordance an exemplary embodiment of the present invention is composed of nodes 1 and 2 that communicate with each other by full-duplex communication function portions 11 and 21.

The nodes 1 and 2 include their respective full-duplex communication function portions 11 and 21, receive buffers 12 and 22, pause control portions 13 and 23, frame transmission control portions 14 and 24, receive buffer accumulation degree increase and processing load detection portions (hereinafter called “processing load detection portions”) 15 and 25, and memories 16 and 26.

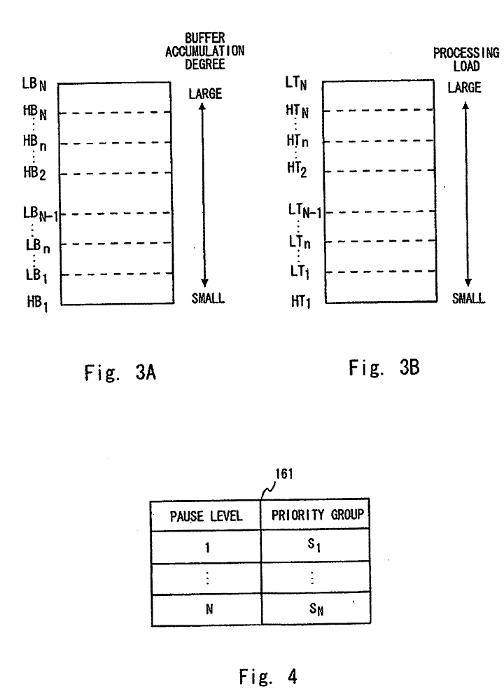

FIGS. 3A and 3B show thresholds for detecting increase in the degree of accumulation at a receive buffer and thresholds for detecting increase in a processing load, respectively, for use in an exemplary embodiment of the present invention. As shown in FIG. 3A, buffer accumulation levels HBₙ and buffer accumulation levels LBₙ are established as thresholds for detecting increase in the degree of accumulation at the receive buffer and thresholds for detecting decrease in the degree of accumulation at the receive buffer, respectively, in each of the node 1 and the node 2. Furthermore, as shown in FIG. 3B, processing load levels HTₙ and processing load levels LTₙ are established as thresholds for detecting increase in the processing load and thresholds for detecting decrease in the processing load, respectively, in each of the node 1 and the node 2.

Increase and decrease in loads at the nodes 1 and 2 are determined based on information about these buffer accumulation levels and processing load levels. Note that “n” is called “pause level”, and its value is an integer satisfying 1≦n≦N. N is a given integer equal to or greater than 2. Furthermore, assume that HBₙ<HBₙ₊₁, LBₙ<LBₙ₊₁, HTₙ<HTₙ₊₁, LTₙ<LTₙ₊₁, LBₙ<HBₙ, and LTₙ<HTₙ.

Furthermore, each of the nodes 1 and 2 retains a current pause level, a temporary transmission stop time that is most recently notified to the opposing node, and a temporary transmission stop time that is most recently notified from the opposing node as a value for detecting pause level change, a value for detecting pause level update timing, and a value for detecting transmission restart timing, respectively.

FIG. 4 shows a configuration of a pause level table retained in a memory 16 shown in FIG. 2. In FIG. 4, priority groups (S₁-S_{N}) for frames to be transmitted are registered for their respective pause levels (“1”-“N”) in a pause level table 161 in order to determine a priority of frames for which transmission should be temporary stopped when the load is increased or to determine a priority of frames for which transmission should be restarted when the processing load is decreased. Note that the memory 26 also stores a pause level table similar to the above-described table.

Note also that Sn is a frame priority group registered for a pause level “n” in the pause level table 161. Assume a case where frames of all priorities are in a transmission state upon the pause level 1 (n=1), and frames of all priorities are in a transmission stop state upon the pause level N (n=N). Under this assumption, all priorities are registered in the priority group S₁ and no priority is registered in the priority group S_{N}.

Upon the pause level 1 (n=1), it is in the full transmission state and there is no frame for which transmission should be stopped. Therefore, the load levels HB₁ and HT₁ for detecting increase in load are unnecessary or set to the lower limit value. Meanwhile, upon the pause level N (n=N), it is in the full transmission stop state and there is no frame for which transmission should be restarted. Therefore, the load levels HB_{N} and HT_{N} for detecting decrease in the processing load are unnecessary or set to the higher limit value.

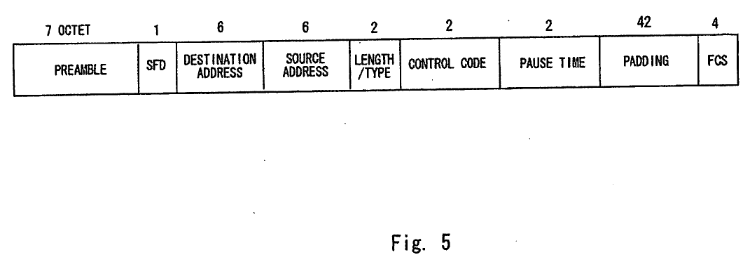

FIG. 5 shows a frame format of a control frame for use in the pause function portions 13 and 23 shown in FIG. 2. In FIG. 5, the control frame is formed based on the pause frame format of the above-described pause function related to the present invention, and is composed of “preamble”, “SFD (Start Frame Delimiter)”, “destination address”, “source address”, “length/type”, “control code”, “pause time”, “padding”, and “FCS (Frame Check Sequence)”.

However, in an exemplary embodiment of the present invention, a pause level and information for frame response request are set in the above-mentioned “padding” area in order to notify the pause information to the opposing node. Note that the information for frame response request is used to confirm whether or not the opposing node supports the pause function with priority taken into account, and has a value indicating “response request”, “response”, or “invalid”.

Note that a control frame whose information for frame response request is “response request” is called “pause function confirmation frame” in the following explanation. A control frame whose information for frame response request is “response” is called “pause function response frame”. A frame whose information for frame response request is “invalid” and whose pause time is not zero is called “pause frame”. A frame whose information for frame response request is “invalid” and whose pause time is zero is called “pause cancel frame”.

Using a structure described above, it is possible to collect necessary information for the flow control function with priority taken into account in an exemplary embodiment of the present invention.

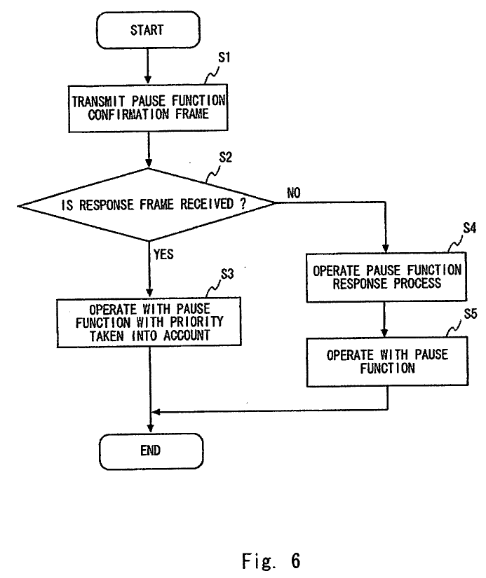

FIGS. 6-11 are flowcharts illustrating flow control operations with priority taken into account in accordance with exemplary embodiments of the present invention. Flow control operations with priority taken into account in accordance with exemplary embodiments of the present invention are explained hereinafter with reference to these FIGS. 2-11. Note that processes shown in FIGS. 6-11 are realized by executing programs by main components of the nodes 1 and 3, i.e., computers (e.g., CPUs (Central Processing Units)) (not shown).

Assume that the pause function with priority taken into account is already enabled in the node 2. In a state where the node 1 is connected to the node 2, when the pause function with priority taken into account is enabled in the node 1 or when a port of the node 1 makes a transition to a link-up state with the pause function with priority taken into account being in the enabled state, the node 1 carries out a process to notify the node 2 (opposing node) that the pause function with priority taken into account becomes enabled.

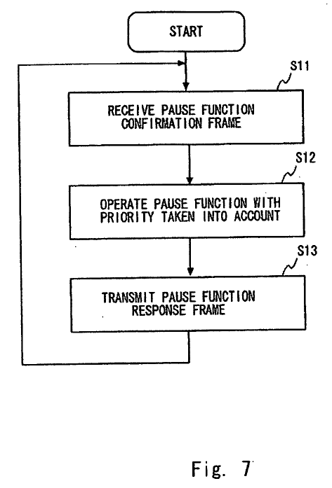

Firstly, the node 1 transmits a pause function confirmation frame to the node 2 (Step S1 in FIG. 6). When the node 2 receives this pause function confirmation frame (Step S11 in FIG. 7), it operates the pause function with priority taken into account (Step S12 in FIG. 7) and transmits a pause function response frame to the node 1 (Step S13 in FIG. 7).

When the node 1 receives this pause function response frame (Step S2 in FIG. 6), it operates the pause function with priority taken into account (Step S3 in FIG. 6).

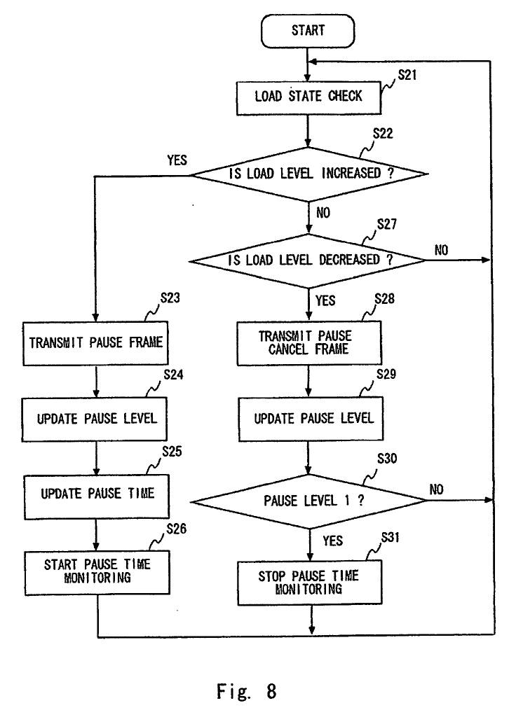

The node 1 checks its own load state (Step S21 in FIG. 8), thereby confirming whether or not the load level is changed. At this point, assume that the current load state of the node 1 is P, the pause level which the node 1 retains is “i”, the load levels for detecting increase in load that are equal to or less than P and are closest to P are HBⱼ and HTₖ, and the load levels for detecting decrease in load that are equal to or greater than P and are closest to P are LB₁ and LTₘ.

With regard to a load increase detection process (Step S22 in FIG. 8), when the formulas j≦i and k≦i are satisfied, it means that the load level is not increased, so that the node 1 does not carry out any process. When either one of the formulas j>i and k>i is satisfied, it means that the load level is increased, so that the node 1 transmits a pause frame to the node 2 (Step S23 in FIG. 8). A pause level “r” that is set in the pause frame at this point is the larger one of the values “j” and “k”.

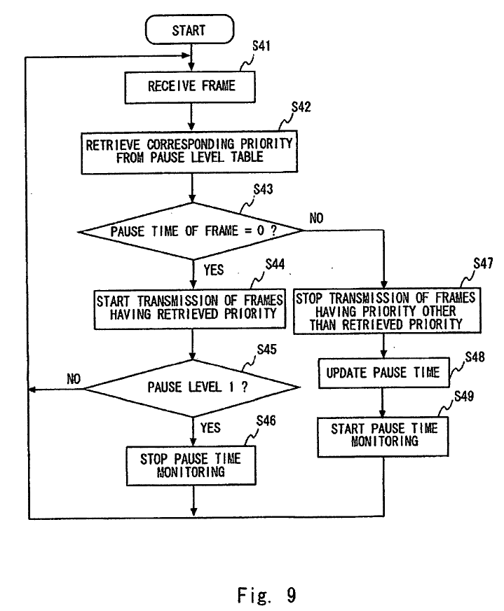

When the node 2 receives this pause frame (Step S41 in FIG. 9), it retrieves a priority group corresponding to the received pause level “r” from the pause level table 261 (Step S42 in FIG. 9). Since the received frame is a pause frame (Step S43 in FIG. 9), the node 2 stops transmission of frames having priorities that do not belong to the retrieved priority group (Step S47 in FIG. 9).

After that, the node 2 retains the received pause time in order to temporarily stop for the pause time designated in the pause frame (Step S48 in FIG. 9), and starts a frame transmission restart monitoring process (Step S49 in FIG. 9).

Furthermore, the node 1 updates the value of the current pause level to “r” (Step S24 in FIG. 8), retains the pause time set in the transmitted pause frame (Step S25 in FIG. 8), and starts a pause level monitoring process (Step S26 in FIG. 8).

With regard to a load decrease detection process (Step S27 in FIG. 8), when either one of the formulas l≧i and m≧i is satisfied, it means that the load level is not decreased, so that the node 1 does not carry out any process. When the formulas j<i and k<i are satisfied, it means that the load level is decreased, so that the node 1 transmits a pause cancel frame to the node 2 (Step S28 in FIG. 8). A pause level “s” that is set in the pause cancel frame at this point is the smaller one of the values “l” and “m”.

When the node 2 receives this pause cancel frame (Step S41 in FIG. 9), it retrieves a priority group corresponding to the received pause level “s” from the pause level table 261 (Step S42 in FIG. 9). Since the received frame is a pause cancel frame (Step S43 in FIG. 9), the node 2 starts transmission of frames having priorities that belong to the retrieved priority group (Step S44 in FIG. 9).

At this point, if the received pause cancel frame indicates the pause level 1 (Step S45 in FIG. 9), the node 2 terminates the frame transmission restart monitoring process (Step S46 in FIG. 9).

Furthermore, the node 1 updates the value of the current pause level to “s” (Step S29 in FIG. 8). At this point, if the pause level s is 1 (Step S30 in FIG. 8), the node 1 terminates the pause level monitoring process (Step S31 in FIG. 8).

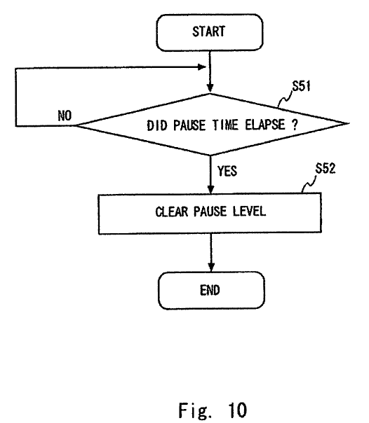

In a state where the node 1 temporarily makes the node 2 stop the frame transmission as the pause level monitoring process (It is hereinafter called “pause state”. This pose state is a state where the pause level is equal to or greater than 2.), when the retained pause time has already elapsed since the transmission of the most recent pause frame (Step S51 in FIG. 10), the pause state is canceled, so that the node 1 initializes the pause level to 1 and terminates the process (Step S52 in FIG. 10).

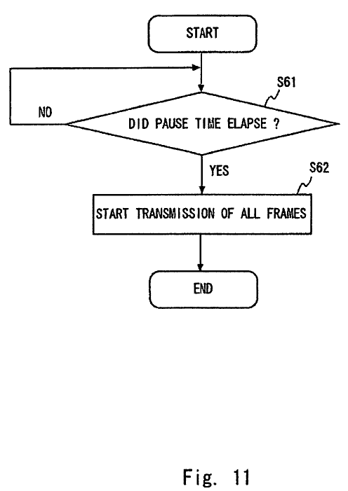

In a state where the node 2 temporarily stops the frame transmission to the node 1 as the frame transmission restart monitoring process, when the retained pause time has already elapsed since the reception of the most recent pause frame from the node 1 (Step S61 in FIG. 11), the pause state is canceled, so that the node 2 starts the transmission of all frames and terminates the process (Step S62 in FIG. 11).

As described above, in an exemplary embodiment of the present invention, it is possible to stop the transmission of frames having a lower priority as the loads are increased at the nodes 1 and 2 and to preferentially transmit frames having a higher priority by using the level-assigned pause frame. Therefore, it is possible to prevent the transmission of frames having a higher priority from being stopped, or to delay the stop of the transmission.

Furthermore, in an exemplary embodiment of the present invention, it is possible to preferentially restart the transmission of frames having a higher priority to be processed when the load at the node in the pause state is decreased by using the level-assigned pause cancel frame. Therefore, it is possible to expedite the restart of the transmission of frames having a higher priority.

Furthermore, in an exemplary embodiment of the present invention, it is possible to confirm whether or not the opposing node supports a pause function with priority taken into account by the pause function confirmation frame and the pause function confirmation response frame. Therefore, it is possible to maintain compatibility with the above-described pause function related to the present invention.

Furthermore, a plurality of load levels can be registered in an exemplary embodiment of the present invention, so that it is possible to carry out frame transmission stop and frame transmission restart at different load level thresholds from each other even when the priority is minutely divided into groups.

Note that the present invention is also applicable, for example, to a modified example of FIG. 2 where the node 2 does not support a pause function with priority taken into account and operates with the above-described pause function related to the present invention. In such a case, when the pause function with priority taken into account is enabled in node 1 or when a port of the node 1 makes a transition to a link-up state with the pause function with priority taken into account being in the enabled state, the node 1 carries out a process to notify the node 2 (opposing node) that pause function with priority taken into account becomes enabled.

Firstly, the node 1 transmits the pause function confirmation frame to the node 2 (Step S1 in FIG. 6). Since the node 2, which received this pause function confirmation frame, is operating with the above-described pause function related to the present invention, it does not refer to the padding area in the pause frame format, but does process the pause function confirmation frame as the pause cancel frame. Therefore, the node 2 does not respond to the node 1.

When timeout occurs in waiting for reception without receiving any pause function response frame (Step S2 in FIG. 6), the node 1 determines that the node 2 does not support the pause function with priority taken into account. However, the node 1 operates only the pause function confirmation response process so that it can performs the pause function confirmation response process when the configuration of the node 2 is changed so as to support the pause function with priority taken into account (Step S4 in FIG. 6), and the node 1 operates the pause function itself with the above-described pause function related to the present invention (Step S5 in FIG. 6).

With the structure and the operation described above, the present invention can obtain such an advantageous effect that the effect of the frame discarding due to increase in the load at the node for frames having a high priority can be minimized.

While the invention has been particularly shown and described with reference to exemplary embodiments thereof, the invention is not limited to these embodiments. It will be understood by those of ordinary skill in the art that various changes in form and details may be made therein without departing from the spirit and scope of the present invention as defined by the claims.

What is claimed is:

1. A communication device comprising:
a full-duplex communication portion that communicates bidirectionally with an opposing device;
a receive buffer that retains data received from the opposing device at the full-duplex communication portion; and
a pause portion that carries out flow control in full-duplex communication according to a pause level determined based on the degree of accumulation at the receive buffer and a processing load at the communication device itself.

2. The communication device according to claim 1, wherein the pause portion temporarily stops the transmission of frames from frames having a lower priority when the processing load and the degree of accumulation at the receive buffer is increased, and temporarily stops the transmission of all frames when the processing load and the degree of accumulation at the receive buffer is increased to a predetermined maximum threshold.

3. The communication device according to claim 2, wherein the pause portion restarts the transmission of frames from frames having a higher priority when the processing load and the degree of accumulation at the receive buffer is decreased during the temporary stop of the frame transmission, and restarts the transmission of all frames when the processing load and the degree of accumulation at the receive buffer is decreased to a predetermined minimum threshold.

4. The communication device according to claim 1, wherein whether or not the opposing device supports the pause portion is confirmed, and the flow control is carried out according to the pause level when the opposing device supports the pause portion.

5. A communication device comprising:
full-duplex communication means that communicates bidirectionally with an opposing device;
a receive buffer that retains data received from the opposing device at the full-duplex communication means; and
pause means that carries out flow control in full-duplex communication according to a pause level determined based on the degree of accumulation at the receive buffer and a processing load at the communication device itself.

6. A flow control method for use in a communication device, comprising:
communicating bidirectionally with an opposing device;
retaining data received from the opposing device at a receive buffer; and
carrying out flow control in full-duplex communication according to a pause level determined based on the degree of accumulation at the receive buffer and a processing load at the communication device itself.

7. The flow control method according to claim 6, wherein the transmission of frames from frames having a lower priority is temporarily stopped when the processing load and the degree of accumulation at the receive buffer is increased, and the transmission of all frames is temporarily stopped when the processing load and the degree of accumulation at the receive buffer is increased to a predetermined maximum threshold.

8. The flow control method according to claim 7, wherein the transmission of frames from frames having a higher priority is restarted when the processing load and the degree of accumulation at the receive buffer is decreased during the temporary stop of the frame transmission, and the transmission of all frames is restarted when the processing load and the degree of accumulation at the receive buffer is decreased to a predetermined minimum threshold.

9. The flow control method according to claim 6, wherein whether or not the opposing device supports the flow control is confirmed, and the flow control is carried out according to the pause level when the opposing device supports the flow control.

10. A program product that causes a communication device to execute:
a process to communicate bidirectionally with an opposing device;
a process to retain data received from the opposing device at a receive buffer; and
a process to carry out flow control in full-duplex communication according to a pause level determined based on the degree of accumulation at the receive buffer and a processing load at the communication device itself.
